(19) United States
(12) Patent Application Publication
(10) Pub. No.: US 2009/0112766 A1
(43) Pub. Date: Apr. 30, 2009

(54) DEVICE INCLUDING MULTIPLE PAYMENT APPLICATIONS

(76) Inventors: Ayman Hammad, Pleasanton, CA (US); Patrick Faith, Pleasanton, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/257,095

(22) Filed: Oct. 23, 2008

Related U.S. Application Data
(60) Provisional application No. 60/982,682, filed on Oct. 25, 2007.

(51) Int. Cl. G06Q 20/00; G06Q 40/00

(52) U.S. Cl. 705/44; 705/39

(57) ABSTRACT

Embodiments of the invention are directed to a method, a system, a device and a computer-readable media for selecting one or more payment application at the point-of-sale and using the select one or more payment applications to conduct a transaction. One embodiment is directed to a method for automatically selecting one or more payment applications to use in a transaction so that the selected payment applications give the consumer an optimized benefit or benefits.

### CROSS-REFERENCES TO RELATED APPLICATIONS

This patent application claims priority to U.S. Provisional Application No. 60/982,682 filed Oct. 25, 2007, entitled “Mobile Phone Payment System and Method,” which is hereby incorporated by reference in its entirety for all purposes.

### BACKGROUND

The use of credit cards, debit cards, and other payment applications are familiar to nearly every consumer in the modern marketplace. Payment applications have become so common that consumers frequently have access to multiple payment applications and have to choose which of these payment applications to use to conduct a transaction. When a consumer conducts a conducts a transaction using one of their potentially many payment applications, consumers must decide which of their payment applications is the most appropriate to use for the instant transaction.

Payment applications, such as credit card and debit cards, frequently offer different terms and incentives. For example, one credit card may offer a lower interest rate than other credit cards. Some credit cards may offer rewards points for various purchases. The number of rewards points earned by the consumer may also be increased for certain types of sales. For example, some credit card may offer double points for groceries or gasoline. Credit cards may also offer coupons or offer other promotional benefits that are valid only for a limited time.

Given this vast array of terms, rewards, and other offers, it is difficult for consumers to keep track of which payment applications give the consumer the best deal for a given transaction. Consumers are often left to guess, at the time and place of sale, which of their various payment applications give the consumers the best deal for a given transaction. This confusion often results in a consumer failing to receive the best possible deal for a transaction.

Embodiments of this disclosure address these and other problems, individually and collectively.

### SUMMARY

Embodiments of the invention are, without limitation, directed to methods, systems, devices and computer-readable media.

One embodiment of the invention is directed to a device. The device comprises a processor, and a computer-readable medium. The computer-readable medium of the device comprises code for automatically determining one or more payment applications that yield an optimized benefit for a consumer from a plurality of payment applications. Each payment application may be associated with a different payment account that can be used to conduct a transaction. The computer-readable medium also comprises code for using the one or more of the determined payment applications to conduct the transaction.

Another embodiment of the invention is directed to a method for automatically determining one or more payment applications that yield an optimized benefit for a consumer from a plurality of payment applications. Each payment application is associated with a different payment account that can be used to conduct a transaction. The method also comprises using one or more of the determined payment applications to conduct the transaction.

These and other embodiments of the invention are described in further detail below.

### BRIEF DESCRIPTION OF THE DRAWINGS

FIG. 1 is an example user display according to one embodiment.

FIG. 2 is an example user display according to one embodiment.

FIG. 3 is a flow chart showing the steps taken according to one embodiment.

FIG. 4 is an example user display according to one embodiment.

FIG. 5 is an example user display according to one embodiment.

FIG. 6 is an example user display according to one embodiment.

FIG. 7 is an example user display according to one embodiment.

FIG. 8 is a block diagram of an exemplary system for conducting a payment transaction.

FIG. 9 is a block diagram of an exemplary portable consumer device that can be used to conduct a payment transaction.

FIG. 10 is a block diagram of subsystems that may be present in computer apparatuses that can be used according to various embodiments.

### DETAILED DESCRIPTION

Embodiments of the invention are directed to methods, systems, devices and computer-readable media. In embodiments of the invention, a processor in a device can automatically select one or more payment applications according to the payment applications which provide the optimal benefit for the consumer at that time. Examples of devices include portable consumer devices (e.g., phones), personal computers, etc.

In one embodiment of the invention, a consumer purchases a number of items from a merchant. The consumer may bring the items to be purchased to a point-of-sale device run by the merchant in order to begin the transaction. The consumer passes a portable consumer device near a contactless reader in the point-of-sale device either while or after the items being purchased are scanned into the point-of sale device. The portable consumer device stores in its memory one or more payment applications that the consumer may use to conduct the transaction. The one or more payment applications may correspond to one or more payment cards that the consumer holds.

When the portable consumer device passes by the contactless reader, the portable consumer device can receive transaction information about the items being purchased from the point-of-sale device. The transaction information may include information identifying the items purchased (e.g., using SKUs), information identifying the merchant (e.g. a merchant ID), other information relating to the transaction itself (e.g. the total value of the transaction), etc. Once the transaction information is received by the portable consumer device, the portable consumer device determines which of the payment applications stored in it will give the consumer the optimal benefit. The determination can occur automatically, and once the optimal payment application is selected by the portable consumer device, the consumer may optionally be asked to confirm that he wants to use the determined payment application to pay for the goods in the current transaction.

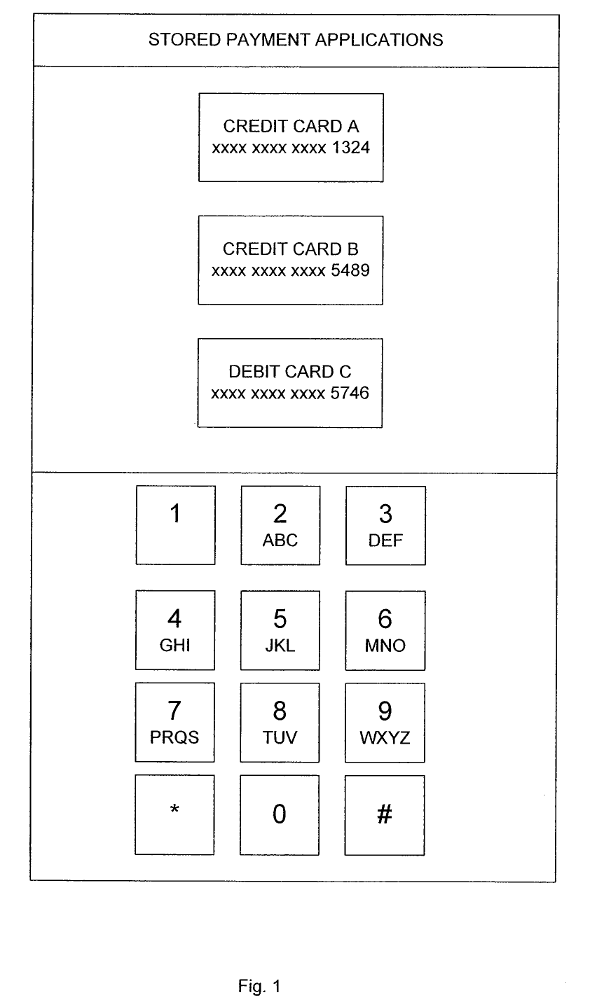

Illustratively, the consumer may have a first credit card, card A, from Bank A, a second credit card, card B, from Bank B, and a first debit card, card C, from Bank C. The first credit card, the second credit card, and the first debit card account numbers and other information (e.g., card verification values, expiration dates, etc.) may have corresponding payment applications that are stored in the memory of his phone. FIG. 1 illustrates how one embodiment might the present payment applications stored in the memory of a phone to a consumer. Each card and each payment application may provide different types of benefits for the consumer. For instance, the first credit card from Bank A may provide 5% cash back when groceries are purchased, the second credit card from Bank B may provide 1% cash back on purchases of any type, and the first debit card from Bank C may provide 2% cash back for purchases relating to travel. In some embodiments, these various types of benefits are stored in the memory of the phone.

In an exemplary transaction the consumer may use the phone to purchase groceries at a supermarket. At the supermarket, the groceries to be purchased are scanned into an access device such as a point of sale terminal or an electronic cash register. Transaction information, including SKU information for the purchased items, passes from the access device to the phone via a wireless communication medium. After receiving the transaction information, the mobile communication device determines that the consumer is purchasing groceries. The mobile communication device may then determine the payment application that provides the optimum benefit for the consumer for the current transaction. For example, the determined payment application may be the payment application that is associated with the first credit card, card A, since the first credit card will provide 5% cash back for purchases made in the current transaction. In contrast, the second credit card and the first debit card may provide no benefit for the consumer if they are used in the current transaction.

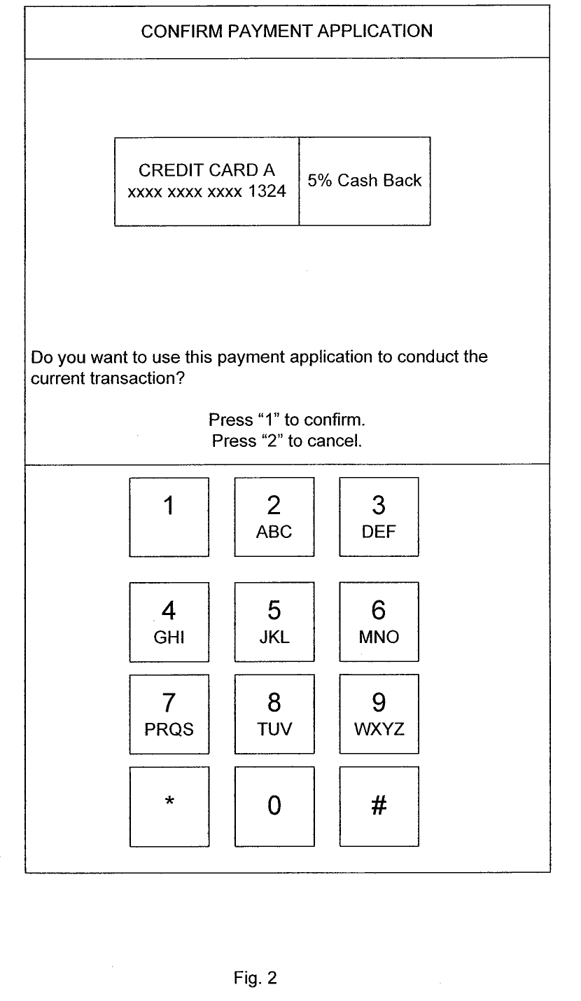

After a processor in the phone automatically selects the payment application associated with the first credit card, card A, an image (e.g., a logo for Bank A and the last four digits of the account number for the first credit card) corresponding to the determined payment application may then automatically show on the phone's display so that the consumer knows which payment application was selected by the phone. The consumer can thereafter optionally confirm that the selected payment application is to be used, by responding to a prompt on the phone (e.g., “Do you want to use this payment application to conduct the current transaction?”). FIG. 2 illustrates how one embodiment confirms the payment application selected with the consumer. If the consumer confirms the selection made by the phone, then the transaction will take place using “Card A.”

After the consumer confirms that he wants to use the determined payment application, the consumer can continue to conduct the transaction by passing the phone by a corresponding contactless element in the merchant's access device. The merchant's access device can thereafter receive information corresponding to the first credit card, including the account number, the expiration date, a card verification value, etc., from the phone. The access device may thereafter send an authorization request message to Bank A, via the supermarket's acquirer, to ask for approval to proceed with the transaction. Bank A checks to see if the consumer has sufficient credit in his account and further verifies that the consumer and the payment application are authentic. If they are, then Bank A may send an authorization response message back to the consumer's phone or to the access device indicating that the transaction has been authorized. A conventional clearing and settlement process can thereafter take place to complete the transaction.

In other embodiments of the invention, the consumer's phone can directly communicate with the issuer via a payment processing network, without communicating through the supermarket's access device or acquirer.

Further details regarding embodiments of the invention are provided below.

I. Multiple Payment Applications on Mobile Communication Device

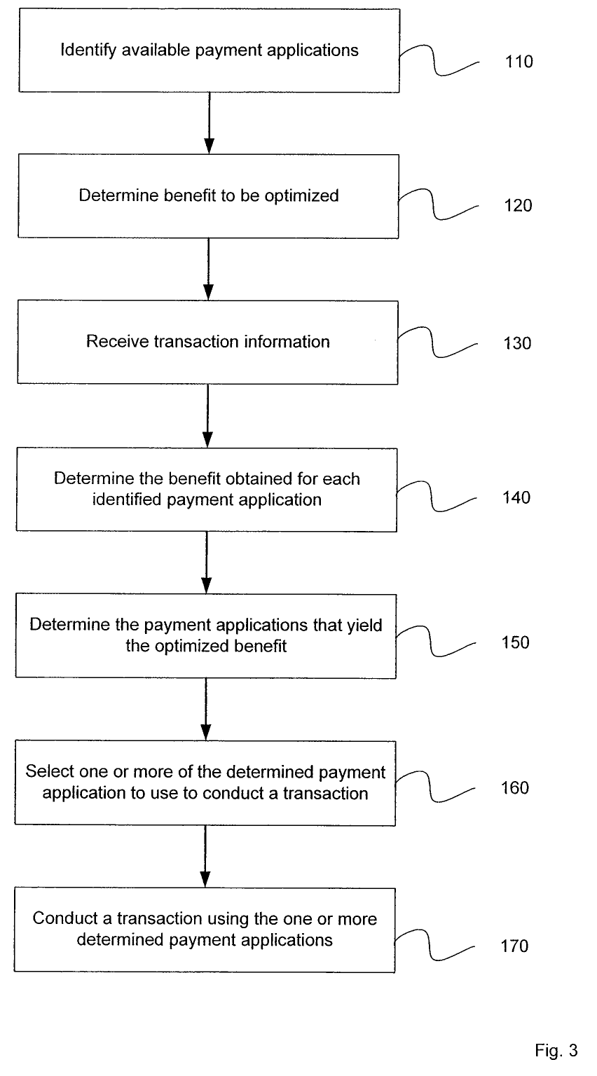

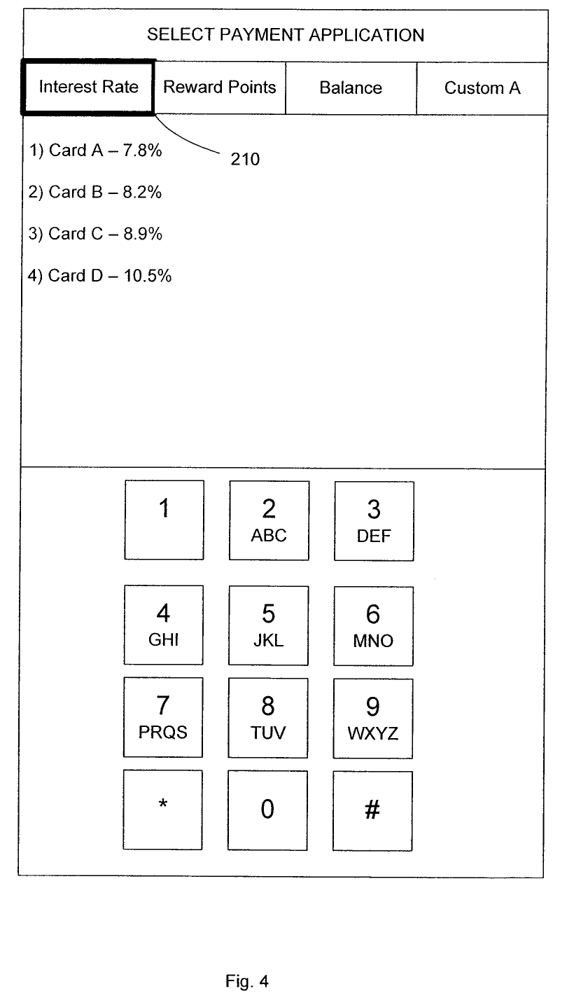

FIG. 3 shows the steps taken according to some embodiments of the invention. The steps in FIG. 3 can be described with reference to the system of FIG. 9 and FIGS. 4-7.

At step 110, one or more payment applications that are available to conduct a transaction are identified. In one embodiment, a processor in a portable consumer device, such as a mobile communication device, identifies the payment applications that are available. A mobile communication device may be in the form of a mobile phone, personal digital assistant (PDA), pager, or the like. A portable consumer device may have multiple payment applications stored in a computer-readable medium in the device, and the processor in the portable consumer device accesses this computer-readable medium in order to identify the available payment applications. The different payment applications are associated with different accounts. These different accounts may be associated with different issuers or may be associated with the same issuer.

In some embodiments, not every payment application will be available for use for every transaction. For example, there may be instances where the expiration date has passed for a payment application, and thus the payment application would no longer be available for use. Another example of a situation in which a payment application might not be available for use is when a merchant does not accept a particular type of payment application. For example, one merchant might not accept debit cards. Another merchant might not accept particular credit cards, such as American Express. Another example of when a payment application might not be available to use in a transaction is when a payment application has a balance over the credit limit for the payment application. Similarly, if a transaction being conducted using a payment application would cause the payment application to exceed its credit limit, then the payment application may not be available for a transaction. A payment application may also be unavailable for a particular transaction, because the value of the transaction exceeds a transactional limit set on the payment application. In some embodiments, the portable consumer device may communicate with a payment processing network to help determine which of the payment applications stored on the portable consumer device are available for use. For example, a portable consumer device may request the available balance on a payment application to determine whether the payment application is available for use in a particular transaction. In some embodiments, the portable consumer device may use specialized software to communicate with a payment processing network. More details on how a portable consumer device might communicate with a payment processing network are discussed later in this disclosure.

At step 120, the benefit or combination of benefits to be optimized are determined. The benefit or benefits to be optimized depend on the preferences of the consumer. For example, one consumer may only care about receiving the lowest interest rate possible for a given transaction. Another consumer may want the most “cash back” offered with his purchase. Yet another consumer may wish to maximize the number of reward points that the consumer will earn for the transaction. As one skilled in the art can see, there are many possibilities for selecting the benefit to be optimized. In one embodiment, the preferences of the consumer are stored in a computer-readable medium in a portable consumer device, and a processor in the portable consumer device access this computer-readable medium to determine the benefit or combination of benefits to be optimized.

In some embodiments, a consumer may not wish to simply optimize a single variable, such as the offered interest rate. Instead, the consumer may wish to optimize the combination of a number of variables. In one embodiment, each variable to be optimized may be given a different weight and each variable may be mapped to a standardized scoring system. The standardized scoring system can be used to compare the relative benefit received by the consumer for disparate variables. For example, the interest rate offered by a card and the number of rewards points earned for a transaction might be hard to directly compare. Additionally, it may be difficult to compare the rewards points earned from two different payment applications. One way to solve this problem is to map these variables to a scoring system that assigns a score for various values of the variable. In one embodiment, the assigned score might range from 1 to 10. Once the variable are mapped using a standardized scoring system, it becomes easier to compare various terms. Standardized scores for different variables can then be weighted according to the consumer's preferences. This combination of scores and weights can then used to determine the optimal combination of benefits to be received by the consumer. Other embodiments may use alternative means to determine the optimum benefit across multiple variables.

In some embodiments, consumers can store their optimization preferences in a consumer profile. Consumer profiles can be created for either single variable optimizations or multiple variable optimizations. One of the stored consumer profiles may be stored as a default consumer profile. In one embodiment, the profile used for a transaction can be selected before a transaction is conducted. In another embodiment, a profile can be selected while a transaction is taking place. Alternatively, a consumer profile can be automatically selected by the portable consumer device based on the type of transaction. For example, if electronics are being purchased or the transaction is taking place at a retailer that deals primarily in electronics, the portable consumer device may recognize this and select the appropriate profile. In some embodiment, the portable consumer device may use a location mechanism, such as GPS, to determine the appropriate consumer profile to use. A GPS module in a mobile communication device may be able to determine that the consumer is a supermarket or at a gas station. An appropriate consumer profile can then be selected based on this information. In another embodiment, information may be communicated to the portable consumer device from an access device, such as a point-of-sale terminal. The information transmitted may contain information on the transaction, on the merchant, or on other data that may be used to help the portable consumer device select an appropriate consumer profile. Many other possibilities for selecting an appropriate consumer profile will be apparent to one skilled in the art. In one embodiment, consumer profiles stored in a computer-readable medium in a portable consumer device, and a processor in the portable consumer device access this computer-readable medium to select a consumer profile.

At step 130, transaction information is received. In some embodiments, a portable consumer device receives transaction information from an access device. The portable consumer device may have a contactless element that is capable of transferring and receiving data using a near field communications (“NFC”) capability. Transaction information may include information identifying the items purchased (e.g., using SKUs), information relating to the merchant (e.g. a merchant ID or location of the merchant), other information relating to the transaction itself (e.g. the total value of the transaction, the location of the transaction), etc. Transaction information may be relevant to determining the optimum benefit in a variety of circumstances. For example, if the benefit to be optimized includes rewards points, certain payment applications may increase the number of points awards for the purchase of particular items. For example, certain payment applications may award double reward points for grocery purchases. Other payment applications may increase the benefits obtained based on the identity or classification of the merchant. For example, some payment applications may give increased benefits for purchases made at gas stations generally or at specific gas stations. Some embodiments may be able to determine the identity or classification of the merchant from information relating to the location of the merchant.

In other embodiments, transaction information received by the portable consumer device can be obtained via an antenna with long range communication capability. For example, position data such as GPS data can be determined in the portable consumer device, and this information along with other data received over a network may be used to determine that the consumer is at a particular merchant. For example, using GPS location data and pre-existing map data, a portable consumer device such as a phone can determine that the consumer is presently conducting a transaction at a gas station. The consumer's phone can then determine that the payment application that provides high rewards for gasoline purchases is the best application for the consumer for the present transaction.

In some embodiments, the transaction information may be received by an access device. The transaction information may include information received from a portable consumer device transferred using a near field communication capability. In one embodiment, the transaction information may include information on the various payment applications stored in a portable consumer device. For example, the portable consumer device may store in a computer-readable medium data tracks that are traditionally associated with credits cards. The portable consumer device may transfer data in these data tracks to an access device via a contactless element. In other embodiment, the transaction information may include information identifying the portable consumer device itself. The information identifying the portable consumer device can then be used by an access device to determine the payment applications associated with the portable consumer device. In one embodiment, the access device may include information identifying the portable consumer device in a request to a payment processing network to determine the payment applications associated with the portable consumer device.

Receiving transaction information is not always necessary to determine the optimum benefit for a consumer. The use of transaction information to determine the optimized benefit for a consumer may depend on the particular payment applications used by a consumer. For example, if the only benefit to be optimized is the interest rate and if none of a consumer's payment applications vary the interest rate because of the details of any transaction, then it may not be necessary to receive any transaction information in order to optimize the consumer's benefit. A processor in a portable consumer device can run code stored in a computer-readable medium that determines whether transaction information is needed.

Step 140, the actual benefit or combination of benefits that would be received using each of the available payment applications are determined. For example, if the lowest available interest rate is the benefit to be optimized, then the portable consumer device may determine the interest rate for the transaction that each available payment application would offer. If a consumer wishes to optimize the reward points that would be earned for a transaction, then the portable consumer device can determine the reward points each payment application would award for the transaction. In some instances, the portable consumer device may not have all of the data necessary to determine the benefit or benefits that would be obtained for a transaction using a given payment application. In this situation, the mobile payment application may communicate with a payment processing network or an access device to try to obtain any missing information. For example, the portable consumer device may attempt to optimize the cost of the transaction to a consumer, and the portable consumer device may request coupons from a payment processing network that are applicable to a transaction. The coupons offered by a payment processing network may vary depending on the payment application. In one embodiment, code for conducting all of these variations may be stored in a computer-readable medium in the portable consumer device and run by a processor in the portable consumer device.

At step 150, the payment application that gives the optimized benefit is determined. In one embodiment, if there is only one benefit to be optimized, then a portable consumer device can select the payment application that yields the optimized benefit for this one variable. For some variables, such as the offered interest rate, the optimized benefit will be the lowest interest rate. For other variables, such as the number of reward points earned, the optimized benefit will be the maximum number of points. If multiple benefits are to be optimized, then the benefits from the various payment applications may be scored and weighted, or otherwise combined, as disclosed earlier in relation to step 120.

In some embodiments, the optimal number of benefits may be obtained by using more than one payment application. For example, a first payment application may offer a very low promotional interest rate up to a maximum amount. A second payment application may offer an interest rate that is lower than the non-promotional interest rate of the first payment application. In this situation, if the consumer wishes to minimize the overall interest rate for the transaction, the consumer may wish to split the charge between the two cards. In some embodiments, the portable consumer device may be able to make this determination automatically for the consumer. In one embodiment, the portable consumer device may be able to recognize that splitting the transaction across multiple payment applications produces a more optimal result than using any single payment application and may present this option to a consumer.

At step 160, one or more of the payment applications are selected to conduct a transaction.

In some embodiments, the mobile communication device automatically select the payment application that the consumer will actually use. In other embodiments, a smaller set of payment applications may be automatically determined from a larger set of payment applications. This smaller set of payment applications and their associated benefits can be presented to the consumer, and the consumer may select one or more of the payment applications from the smaller set of payment applications for use in the transaction. In one embodiment, the payment applications available for use may be presented to the consumer in a ranked list, wherein the rank of the payment applications is determined by the how well a payment application in the list optimizes the benefit to be received.

At step 170, a transaction is conducted using the selected one or more payment applications. In some embodiments, the information on the selected one or more payment applications is transferred to an access device using a contactless element in the portable consumer device that is capable of transferring and receiving data using a near field communications (“NFC”) capability. Exemplary transaction steps are described in more detail later in this disclosure.

In some embodiments, the steps outlined in FIG. 3 all occur automatically and are conducted by a portable consumer device. For example, in one embodiment, a consumer may swipe a portable consumer device near an access device, such as a point-of-sale device, to conduct a transaction. The consumer swipes the portable consumer device by the access device with the intention of using one or more of the payment applications to conduct a transaction. The steps outlined in FIG. 3 are then conducted by the portable consumer device. As a result, the transaction is conducted using one or more payment applications that have been automatically selected by the portable consumer device to give the consumer an optimized benefit or benefits.

In some embodiments, some of the steps outlined in FIG. 3 may be conducted by devices or entities other than a portable consumer device. For example, the access device may display available payment applications and their associated benefits to the consumer so that the consumer can select the payment application to be used to conduct the transaction. In another embodiment, an access device or a payment processing network may assist in helping the portable consumer device determine the benefit or benefits to be obtained. In yet another embodiment, a client computer such as one that is used in a card not present type of situation, may perform the methods described herein. In another embodiment, various payment applications are stored in a database managed by an e-commerce retailer, and server computers managed by the retailer perform the method described herein.

Alternative embodiments may omit some of the steps shown in FIG. 3 or may add additional steps not shown in FIG. 3. For example, one embodiment may allow a consumer to select a particular consumer profile that will help determine the benefit or benefits to be optimized. Some embodiments may allow a user to confirm the selection of a payment application made by the portable consumer device. Other embodiments may omit the step of receiving transaction information.

FIGS. 4-6 show various example screenshots of a portable consumer device, in the form of a generic mobile phone, which may be presented to a consumer according to various embodiments of the invention. In some embodiments, similar screenshots may be presented to a consumer using a display associated with an access device or using a display associated with a person computer. The embodiments that might utilize screens similar to FIG. 4-6 are embodiments that request a consumer's input or confirmation before conducting a transaction with one or more payment applications.

FIG. 4 shows four separate payment applications, A-D, that have been presented to a consumer. Payment applications A-D may represent credit cards, debit cards, or potentially other payment applications. In the screenshot shown in FIG. 4, the benefit optimized is the interest rate offered by the various payment applications, as indicated by highlighted box 210. In one embodiment, the consumer may type the number corresponding to the payment application the consumer wishes to use to conduct a transaction.

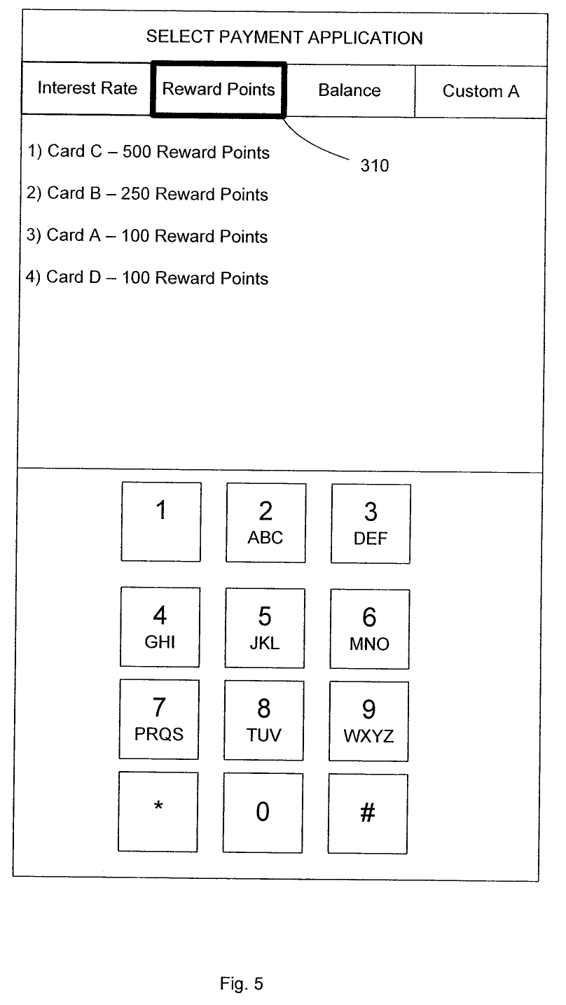

FIG. 5 shows four separate payment applications, A-D, that have been presented to a consumer. In the screenshot shown in FIG. 5, the benefit optimized is the number of rewards points that would be earned using each payment application, as indicated by highlighted box 310. In one embodiment, the user may have switched from the screenshot shown in FIG. 4 to the screenshot shown in FIG. 5 by clicking on box 310. Typically, the number of rewards points earned using a payment transaction is dependent on the value of the transaction. In the embodiment shown in FIG. 5, the value of the transaction has been communicated to the portable consumer device by an appropriate means. For example, this information may have been communicated to the portable consumer device when the portable consumer device was swiped near an access device.

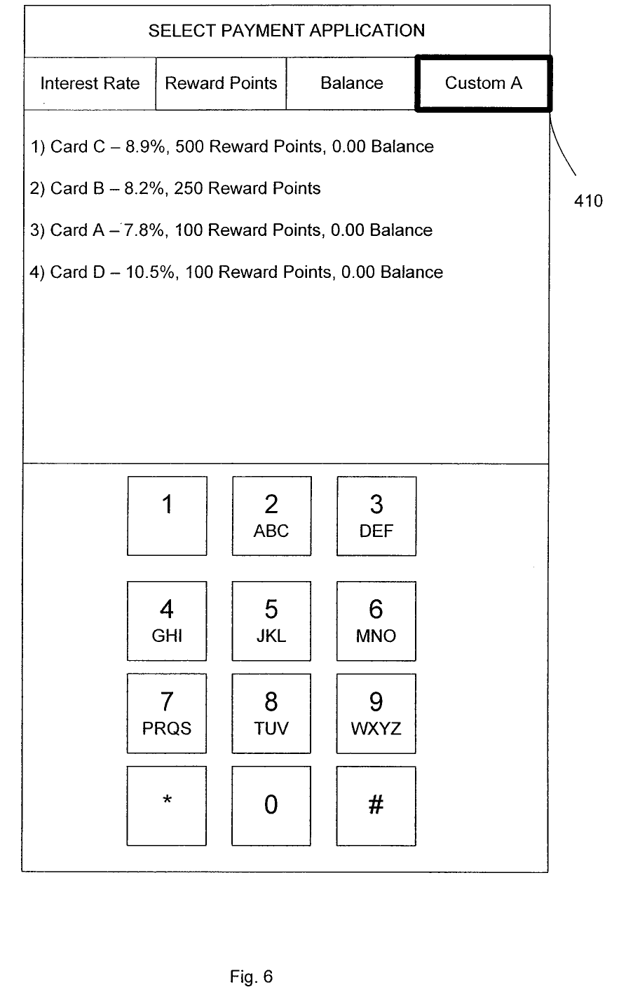

FIG. 6 shows a screenshot illustrating an example of multiple benefits being optimized for a transaction. In the embodiment shown in FIG. 6, the benefits are being optimized according to a consumer profile labeled “Custom A,” as indicated by the highlighted box 410. In FIG. 6, the payment applications have been ranked by the portable consumer device according to the optimized benefit across three variables: interest rate, reward points, and balance. In this embodiment, the payment application represented by “Card C” represents the best overall offer for the consumer. The consumer may wish to select “Card C” to conduct a transaction, but the consumer may elect to use another card if the consumer so desires. In some embodiments, the variables of interest rate, reward points, and balance have been mapped to a standardized scoring system and weighted to determine the optimum benefit as previously disclosed.

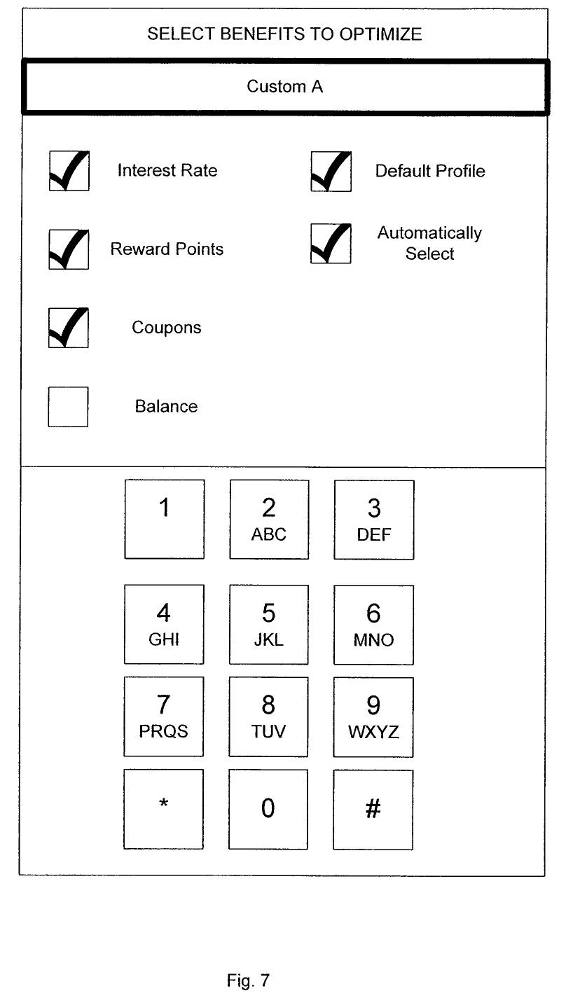

FIG. 7 shows another screenshot of a portable consumer device, in the form of a generic mobile phone, which may be presented to a consumer according to various embodiments of the invention.

The screenshot shown in FIG. 7 shows a consumer selecting the benefits to be optimized when selecting one or more payment applications to conduct a transaction. In the embodiment shown in FIG. 7, the consumer has selected interest rate, reward points, and available coupons as the variables to be optimized for consumer profile “Custom A.” The consumer has elected not to optimize the balance on any payment application. There is also an option to select “Custom A” as the default consumer profile to be used to conduct most transactions. The consumer, in the example shown in FIG. 7, has selected to use “Custom A” as the default profile. As disclosed earlier, a default profile will be the initial profile used to determine the optimized benefits for the consumer. Also, there is an option to allow the portable consumer device to automatically conduct a transaction using the payment applications that yield the determined optimized benefits. The consumer as selected this option. As disclosed earlier, this option indicates that the portable consumer device will automatically select and use the selected payment applications to conduct a transaction at an access device.

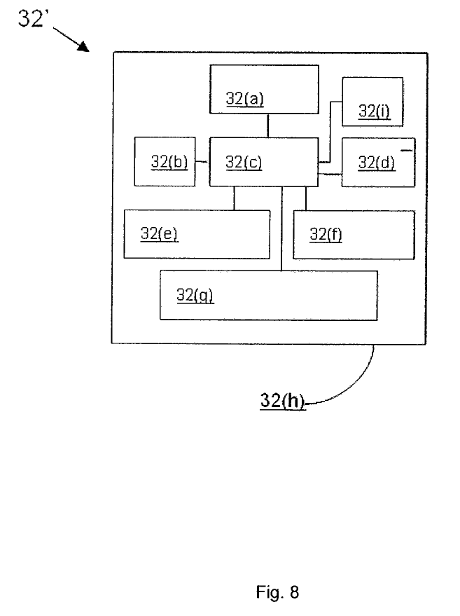

An exemplary portable consumer device 32′ in the form of a phone may comprise a computer readable medium and a body as shown in FIG. 8. (FIG. 8 shows a number of components, and the portable consumer devices according to embodiments of the invention may comprise any suitable combination or subset of such components.) The computer readable medium 32(b) may be present within the body 32(h), or may be detachable from it. The body 32(h) may be in the form a plastic substrate, housing, or other structure. The computer readable medium 32(b) may be a memory that stores data and may be in any suitable form including a magnetic stripe, a memory chip, etc. The memory preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc. Any of this information may be transmitted by the portable consumer device 32′.

In some embodiments, and regardless of the type of portable consumer device that is used, information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The portable consumer device 32′ may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) portable consumer device 32′ and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 32′ and an interrogation device. Thus, the portable consumer device 32′ is capable of communicating and transferring data and/or control instructions via both cellular network and near field communications capability.

The portable consumer device 32′ may also include a processor 32(c) (e.g., a microprocessor) for processing the functions of the portable consumer device 32′ and a display 32(d) to allow a consumer to see phone numbers and other information and messages. The portable consumer device 32′ may further include input elements 32(e) to allow a consumer to input information into the device, a speaker 32(f) to allow the consumer to hear voice communication, music, etc., and a microphone 32(i) to allow the consumer to transmit her voice through the portable consumer device 32′. The portable consumer device 32′ may also include an antenna 32(a) for wireless data transfer (e.g., data transmission).

II. Exemplary Systems and Payment Transactions

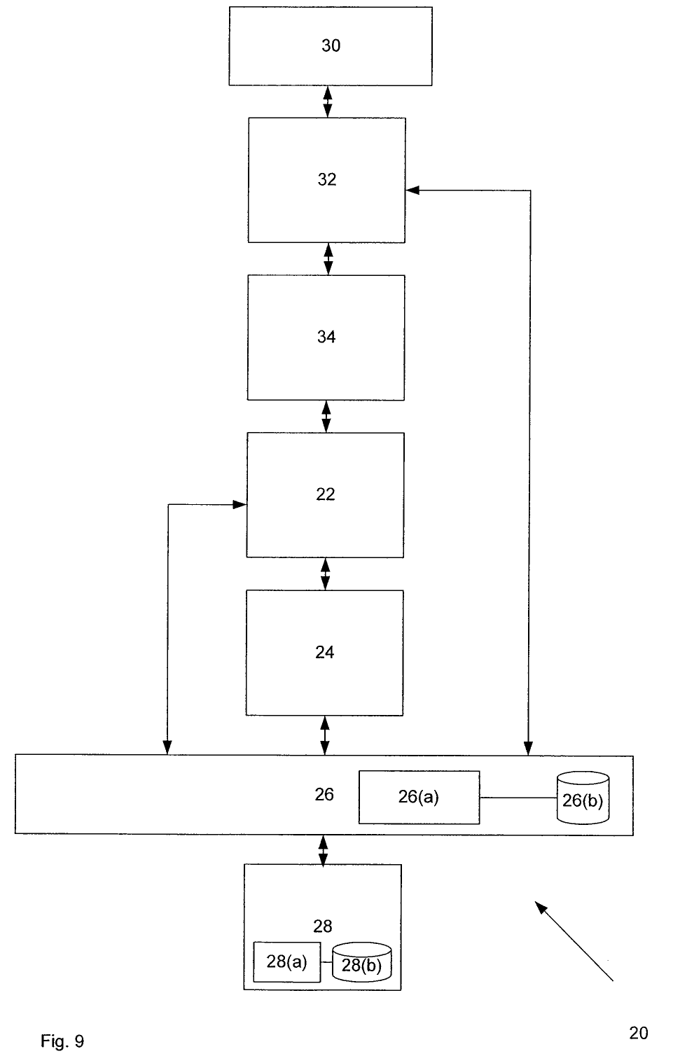

FIG. 9 shows a system 20 that can be used to conduct a payment transaction according in an embodiment. The system 20 includes a merchant 22 and an acquirer 24 associated with the merchant 22. In a typical payment transaction, a consumer 30 may purchase goods or services at the merchant 22 using a portable consumer device 32. In some embodiments, the portable consumer device 32 is a wireless portable consumer device, such as a mobile phone. In some embodiments, the portable consumer device 32 communicates with an access device 34 associated with the merchant. The acquirer 24 can communicate with an issuer 28 via a payment processing network 26.

The consumer 30 may be an individual, or an organization such as a business that is capable of purchasing goods or services.

The portable consumer device 32 may be in any suitable form. For example, some portable consumer devices can be hand-held and compact so that they can fit into a consumer's wallet and/or pocket (e.g., pocket-sized). The portable consumer device 32 typically comprises a processor, and a memory, input devices, and output devices, operatively coupled to the processor. In some embodiments, the portable consumer device is a mobile communication device. Specific examples of portable consumer devices include cellular or wireless phones, personal digital assistants (PDAs), pagers, desktop computers, laptop computers, smart cards, and the like. The portable consumer devices can also be debit devices, credit devices, or stored value devices. As previously described, a portable consumer device may be able to store data relating to a plurality of payment applications. If the portable consumer device lacks a means to process data or run computer code, then the processes described herein may be run on other devices that do contain appropriate processing means, such as an access device.

The merchant 22 may also have, or may receive communications from, an access device 34 that can interact with the portable consumer device 32. The access devices according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If the access device 34 is a point of sale terminal, any suitable point of sale terminal may be used including card or phone readers. The card or phone readers may include any suitable contact or contactless mode of operation. For example, exemplary readers can include RF (radio frequency) antennas, magnetic stripe readers, etc. to interact with the portable consumer devices 32. Some access devices may have displays that allow information to be communicated to a consumer. Some embodiments of access devices may have processors and memory so that the access device is capable of executing the methods disclosed herein.

Acquirer 24 refers to any suitable entity that has an account with merchant 22. For example, acquirer may be a bank that operates a bank account for merchant.

The payment processing network 26 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 26 may include a server computer 26(a), which may be coupled to a database 26(b). A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 26 may use any suitable wired or wireless network, including the Internet. The database 26(b) may include consumer information, account number information for various issuers, etc.

The payment processing network 26 in system 20 is also connected to various manufactures 29 and merchants 22, in addition to issuers 28 and acquirers 24. This interconnectivity between all of these parties allows for many new applications and services to be provided to all connected parties.

Issuer 28 refers to any suitable entity that may open and maintain an account associated with consumer 30. Some examples of issuers may be a bank, a business entity such as a retail store, or a governmental entity. In many cases, issuer may also issue a payment card to consumer. In some embodiments, issuer may also be the acquirer 24. The issuer 28 may also operate a server computer 28(a), and a database 28(b) coupled to the server computer 28(a). The database 28(b) may contain information about accounts that are held by consumers that are affiliated with the issuer 28.

In FIG. 9, although separate functional blocks are shown for an issuer, payment processing network, and acquirer, some entities perform all of these functions and may be included in embodiments of invention.

In a typical purchase transaction, the consumer 30 purchases goods or services at the merchant 22 using the portable consumer device 32 such as a mobile phone. The consumer's portable consumer device 32 can interact with an access device 34 such as a POS (point of sale) terminal at the merchant 22. An authorization request message including the amount of the purchase, account information, etc. is generated by the access device 34, and is sent to the acquirer 24, which can then be forwarded to the issuer 28 via the payment processing network 26. The issuer 28 can then approve or not approve of the transaction (e.g., depending upon whether or not there is sufficient credit and/or if the transaction is deemed authentic). The issuer 28 can then send an authorization response message back to either the portable consumer device 32 via the payment processing network 26, or to the access device 34 via the payment processing network 26 and the acquirer 24.

In another method for conducting a purchase transaction, the portable consumer device 32 is capable of communicating directly with the payment processing network 26, without using an access device 34. Information may be sent from the portable consumer device 32 to the payment processing network 26 without passing through the acquirer 34. The information may include the amount of a transaction, the merchant ID, information about the portable consumer device itself (e.g., phone number, SIM card number, etc.), or any other relevant data. The information may be sent using SMS through a short code, MMS (multimedia message), etc. Once the information is received at the payment processing network 26, the payment processing network 26 (or the server 26(a) in the payment processing network) can retrieve additional information such as any account numbers associated with any determined payment applications in the portable consumer device 32. This additional information may be stored at the payment processing network 26 in the database 26(b), and it may link portable consumer device data to account numbers. In such embodiments, the portable consumer device 32 need not send account number information to the payment processing network 26, thereby enhancing security. Once this information is received by the payment processing network 26, an authorization request message may be reformatted and then forwarded to an issuer 28. An authorization response message may then be generated and then sent back to the consumer 30 by the issuer 28 as described above.

When a portable consumer device 32 can communicate with an access device 34, such as a point of sale, the level of sophistication increases. For example, SKUs can be transferred from the POS terminal to the mobile phone. This SKU information may be used by the portable consumer device to help select the optimal payment application to use for a transaction.

In embodiments of the invention, the portable consumer device 32 may have specialized software that allows the device to interact directly with the payment processing network 26. The specialized software may be able to use a secure protocol or secure channel to communicate with a the payment processing network 26. The portable consumer device may request additional information from the payment processing network concerning any payment applications stored on the portable consumer device. For example, the portable consumer device may request the outstanding balance for a payment application or request coupons available for an ongoing transaction. This information can then be used by the portable consumer device to help determine the optimum payment application to use for a transaction.

III. Computer Apparatuses

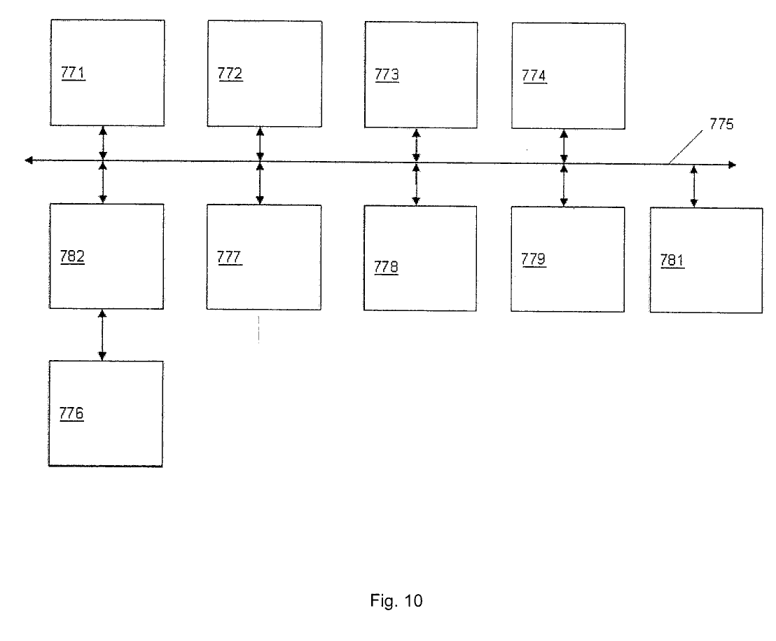

FIG. 10 shows a block diagram of subsystems that may be present in computer apparatuses that can be used according to various embodiments.

The various participants and elements in the previously described Figures may operate using one or more computer apparatuses to facilitate the functions described herein. Any of the elements in the Figures (e.g., server computers 26(a), and 28(a)) may use any suitable number of subsystems to facilitate the functions described herein. Examples of such subsystems or components are shown in a FIG. 10. The subsystems shown in FIG. 10 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium. Any of these elements may be present in the previously described features.

A computer readable medium according to an embodiment may comprise code for performing any of the functions described above. For example, the previously described mobile communication device may comprise a processor with a computer readable medium comprising code for carrying out the process shown in FIG. 3.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

All patents, patent applications, publications, and descriptions mentioned above are herein incorporated by reference in their entirety for all purposes. None is admitted to be prior art.

What is claimed is:

1. A device comprising:
a processor; and
a computer-readable medium coupled to the processor, wherein the computer-readable medium stores code for automatically determining one or more payment applications from a plurality of payment applications, wherein the determined one or more payment applications yields an optimized benefit for a consumer, and code for using the one or more of the determined payment applications to conduct a transaction, and wherein each payment application in the plurality of payment applications is associated with a different payment account.

2. The device of claim 1 wherein the payment applications in the plurality of payment applications are associated with various issuers.

3. The device of claim 1 wherein the optimized benefit is determined by the greatest number of points, the lowest interest rate, or the largest discount the consumer would obtain by conducting the transaction using the determined payment application.

4. The device of claim 1 wherein the device further comprises a contactless element, wherein the contactless element is configured to communicate information concerning the one or more determined payment applications to an access device in order to conduct the transaction.

5. The device of claim 1 wherein the device further comprises a contactless element, wherein the contactless element is configured to communicate information concerning the one or more determined payment applications to a payment processing network in order to conduct the transaction.

6. The device of claim 1 wherein the device further comprises a contactless element, wherein the contactless element is configured to receive transaction information and wherein the optimized benefit is determined at least in part using the transaction information received.

7. A method comprising:
automatically determining one or more payment applications that yield an optimized benefit for a consumer from a plurality of payment applications, wherein each payment application is associated with a different payment account; and
using one or more of the determined payment applications to conduct a transaction.

8. The method of claim 7 wherein the payment applications in the plurality of payment applications are associated with various issuers.

9. The method of claim 7 wherein the optimized benefit is determined by the greatest number of points, the lowest interest rate, or the largest discount the consumer would obtain by conducting the transaction using a payment application.

10. The method of claim 9 wherein a consumer profile is used to assign various weights to the greatest number of points, the lowest interest rate, or the largest discount when determining the optimized benefit.

11. The method of claim 7 further comprising:
presenting the one or more determined payment applications to a consumer;
wherein the consumer selects which of the one or more determined payment applications will be used to conduct the transaction.

12. The method of claim 11 wherein presenting one or more payment applications to a consumer comprises:
ranking the one or more determined payment applications according to the optimized benefit; and
presenting the one or more determined payment applications to the consumer according to the ranking of the one or more determined payment applications.

13. The method of claim 7 wherein the optimized benefit is determined using information requested from a payment processing network.

14. The method of claim 7 wherein the step of using one or more of the determined payment applications to conduct a transaction further comprises:
sending information concerning the determined one or more payment applications to an access device, wherein the access device uses the information concerning the determined one or more payment applications to authorize the payment for the transaction.

15. The method of claim 7 wherein the step of using one or more of the determined payment applications to conduct a transaction further comprises:
sending an authorization request message to a payment processing network, wherein the authorization request message includes information concerning the determined one or more payment applications and information associated with the transaction, and wherein the payment processing network uses the information concerning the determined one or more payment applications to authorize the payment for the payment transaction.

16. The method of claim 15 wherein the payment processing network sends an authorization response message to a portable consumer device.

17. The method of claim 15 wherein the payment processing network sends an authorization response message to an access device of a merchant.

18. The method of claim 7 wherein transaction information is received at a portable consumer device, and wherein the portable consumer device automatically determines the one or more payment applications and wherein the portable consumer device uses the one or more determined payment applications to conduct the transaction.

19. The method of claim 18 wherein the optimized benefit is determined at least in part by the transaction information received at the portable consumer device.

20. A computer-readable medium comprising code for performing the method of claim 7.
